(19) United States
(12) Patent Application Publication
(10) Pub. No.: US 2020/0209688 A1
(43) Pub. Date: Jul. 2, 2020

(54) DISPLAY MODULE AND ELECTRONIC DEVICE

(71) Applicant: Wuhan China Star Optoelectronics Technology Co., Ltd., Wuhan (CN)

(72) Inventor: Bin ZHAO, (US)

(73) Assignee: Wuhan China Star Optoelectronics Technology Co., Ltd., Wuhan (CN)

(21) Appl. No.: 16/476,556

(22) PCT Filed: Apr. 16, 2019
(86) PCT No.: PCT/CN2019/082815

§ 371 Date: Jul. 9, 2019

(30) Foreign Application Priority Data
Dec. 27, 2018 (CN) 201811607235.1

(51) Int. Cl. G02F 1/13357; G02F 1/1335; F21V 8/00

(52) U.S. Cl. CPC G02F 1/133609; G02F 1/133514; G02F 2001/136222; G02B 6/0078; G02F 1/133528

(57) ABSTRACT

A display module includes a backlight module and a liquid crystal display panel. The backlight module has a light source. The liquid crystal display panel has an array substrate, wherein the array substrate is provided with a blue filter film on a side close to the light source.

### FIELD OF INVENTION

This invention relates to the field of display technologies and particularly to a display module and an electronic device.

### BACKGROUND OF INVENTION

In recent years, the thin film transistor-liquid crystal display (TFT_LCD) is continuously developing and has gradually been applied to electronic devices such as mobile phones.

As shown in FIG. 1, the conventional display module 100 includes a light source 11 and a TFT_LCD display panel 12. The color of the light on a side close to the light source is bluer than the color of the light on another side away from the light source, so the colors on these sides are uneven, thereby resulting in poor chromaticity uniformity. The conventional method of reducing the chromaticity difference is by adjusting the dot pattern of the light guide plate (LGP). But in practical mass production process, this method can only improve the chromaticity difference between the side close to the light source and the side away from the light source within ±0.010. After the display module is formed, due to factors such as the color mixing of pixels of the liquid crystal display panel and the dots of the backlight, the chromaticity difference may exceed ±0.015, and the problem of poor chromaticity uniformity cannot be effectively solved, and the display effect is reduced.

Therefore, it is necessary to provide a display module and an electronic device to solve the problems existed in the prior art.

### SUMMARY OF INVENTION

An object of the present invention is to provide a display module and an electronic device capable of improving chromaticity uniformity and display effect.

In order to solve the above technical problem, the present invention provides a display module, including:

a backlight module, which includes a light source; and

a liquid crystal display panel, which includes an array substrate, wherein the array substrate is provided with a blue filter film on a side close to the light source.

According to the display module of the present invention, a material of the blue filter film includes at least one of ocular lens pigment (OLP) and melanin.

According to the display module of the present invention, a mixing ratio of the ocular lens pigment and the melanin is within a predetermined range.

According to the display module of the present invention, the backlight module further includes a light guide plate, the light guide plate is disposed above the light source, and the blue filter film is disposed between the light guide plate and a top of the array substrate.

According to the display module of the present invention, the array substrate includes a polarizer, and the blue filter film is disposed between the polarizer and the light guide plate.

According to the display module of the present invention, the blue filter film is attached to the polarizer by an optical adhesive layer.

According to the display module of the present invention, the array substrate includes a polarizer and a base substrate, and the blue filter film is disposed between the polarizer and the base substrate.

According to the display module of the present invention, the base substrate includes a glass substrate and a switch array layer, the switch array layer is disposed on a second surface of the glass substrate, and the polarizer is disposed on a first surface of the glass substrate.

According to the display module of the present invention, the blue filter film is disposed between the polarizer and the glass substrate.

According to the display module of the present invention, the blue filter film is used to filter light having a predetermined wavelength.

According to the display module of the present invention, the blue filter film is used to block ultraviolet.

The invention also provides an electronic device including any one of the above display modules.

In the display module and the electronic device of the present invention, by providing a blue filter film on the side of the liquid crystal display panel close to the light source, a part of the blue light is filtered by the filter film, thereby reducing the blue light emitted from the light source. Therefore, the color close to the light source is the same with the color away from the light source, and the chromaticity is uniform, which improves the display effect.

### DESCRIPTION OF DRAWINGS

FIG. 1 is a schematic view of the conventional display module.

FIG. 2 is a schematic view of the display module in the first embodiment according to the present invention.

FIG. 3 is a schematic view of the structure of the polarizer according to the present invention.

FIG. 4 is a schematic view of the display module in the second embodiment according to the present invention.

### DETAILED DESCRIPTION OF PREFERRED EMBODIMENTS

The following description of the various embodiments is provided to illustrate the specific embodiments. Directional terms mentioned in this invention, such as [upper], [lower], [front], [back], [left], [right], [inside], [outside], [side], etc., are only the direction of the drawing for reference. Therefore, the directional terminology used is for the purpose of illustration and understanding, and is not intended to be limited. In the figure, structurally similar elements are denoted by the same reference numerals.

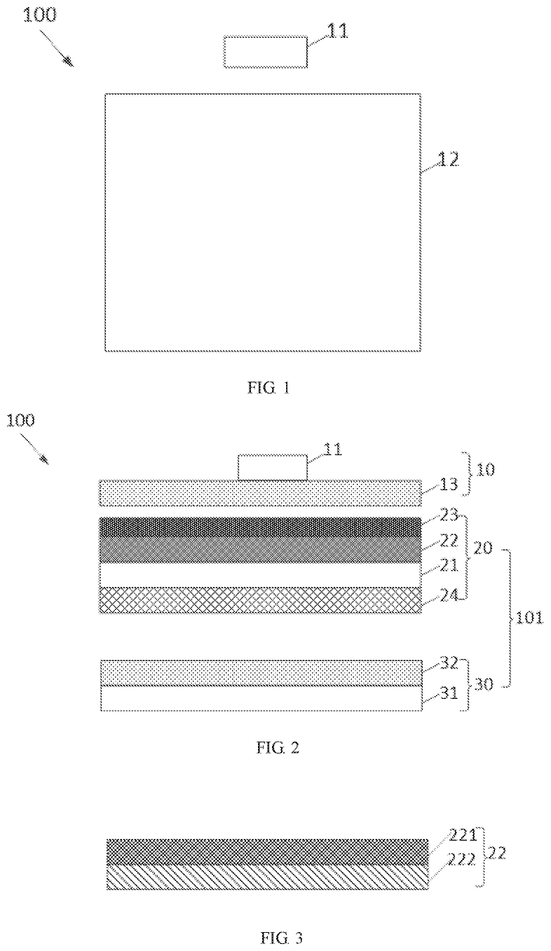

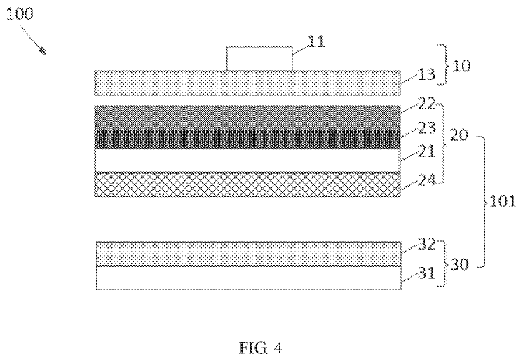

Referring to FIGS. 2-3, FIG. 2 is a schematic structural view of a display module according to the first embodiment according to the present invention.

As shown in FIG. 2, the display module of the present invention includes a backlight module 10 and a liquid crystal display panel 101.

The backlight module 10 includes a light source 11 and may further include a light guide plate 13. The light guide plate 13 is located above the light source 11.

The liquid crystal display panel includes an array substrate 20 and a color filter substrate 30, wherein the array substrate 20 is provided with a blue filter film 23 on a side close to the light source 11. The blue filter film 23 is disposed between the light guide plate 13 and a top of the array substrate 20.

The array substrate 20 includes a glass substrate 21, a switch array layer 24, a polarizer 22, and a blue filter film 23. The switch array layer 24 is disposed on a second surface (lower surface) of the glass substrate 21, and the polarizer 22 is disposed on a first surface (upper surface) of the glass substrate 21. The switch array layer 24 includes a plurality of thin film transistors.

As shown in FIG. 3, the polarizer 22 includes a protective layer 221 and a polarizing film 222 which are sequentially disposed from top to bottom, and may further include a third adhesive layer and an advanced polarizer film (APF) layer. A material of the third adhesive layer may be a pressure sensitive adhesive (PSA) layer.

The blue filter film 23 is disposed between the polarizer 22 and the light guide plate 13. In one embodiment, the blue filter film 23 is attached to the polarizer 22 by an optical adhesive layer (not shown).

In one embodiment, in order to filter blue light more effectively and improve chromaticity uniformity, a material of the blue filter film 23 including at least one of ocular lens pigment (OLP) and melanin is provided, wherein a mixing ratio of the ocular lens pigment and the melanin is within a predetermined range.

The blue filter film 23 is used to filter light having a predetermined wavelength. For example, the blue filter film 23 is used to filter light having a wavelength in the range of 380 nm to 420 nm. The blue filter film 23 can block high energy blue-violet light (wavelength in the range of 380-420 nm). The blue filter film 23 can also block ultraviolet.

The color filter substrate 30 includes another glass substrate 31 and a color resist layer 32. The color resist layer 32 is disposed on the glass substrate 31.

The light emitted from the light source is a composite light, which is composed of seven lights of different frequencies of red, orange, yellow, green, cyan, blue, and purple. The wavelengths and frequencies of the lights are different, and there is more blue light on the side close to the light source than on the side away from the light source. Therefore, by providing a blue filter film on the side of the liquid crystal display panel close to the light source, a part of the blue light is filtered by the filter film, thereby reducing the blue light emitted from the light source, and making the color more yellow. Then the color of the light close to the light source is the same with the color of the light away from the light source, and the chromaticity is uniform, which improves the display effect.

In the display module of the present invention, by providing a blue filter film on the side of the liquid crystal display panel close to the light source, a part of the blue light is filtered by the filter film, thereby reducing the blue light emitted from the light source. Therefore, the color of the light close to the light source is the same with the color of the light away from the light source, and the chromaticity is uniform, which improves the display effect.

Referring to FIG. 4, FIG. 4 is a schematic structural view of a display module according to the second embodiment according to the present invention.

As shown in FIG. 4, the display module of the present invention includes a backlight module 10 and a liquid crystal display panel 101.

The backlight module 10 includes a light source 11 and may further include a light guide plate 13. The light guide plate 13 is disposed above the light source 11.

The liquid crystal display panel includes an array substrate 20 and a color filter substrate 30, wherein the array substrate 20 is provided with a blue filter film 23 on a side close to the light source 11.

The array substrate 20 includes a base substrate, a polarizer 22 and a blue filter film 23. The substrate includes a glass substrate 21 and a switch array layer 24. The switch array layer 24 is disposed on a second surface (lower surface) of the glass substrate 21, and the polarizer 22 is disposed on a first surface (upper surface) of the glass substrate 21. The switch array layer 24 includes a plurality of thin film transistors.

As shown in FIG. 3, the polarizer 22 includes a protective layer 221 and a polarizing film 222 which are sequentially disposed from top to bottom, and may further include a third adhesive layer and an advanced polarizer film (APF) layer. A material of the third adhesive layer may be a pressure sensitive adhesive (PSA) layer.

The blue filter film 23 is disposed between the polarizer 22 and the base substrate. For example, the blue filter film 23 is disposed between the polarizer 22 and the glass substrate 21. In one embodiment, the blue filter film 23 is attached to the glass substrate 21 by an optical adhesive layer.

In one embodiment, in order to filter blue light more effectively and improve chromaticity uniformity, a material of the blue filter film 23 including at least one of ocular lens pigment (OLP) and melanin is provided.

The blue filter film 23 is used to filter light having a predetermined wavelength. For example, the blue filter film 23 is used to filter light having a wavelength in the range of 380 nm to 420 nm. The blue filter film 23 can block high energy blue-violet light (wavelength in the range of 380-420 nm). The blue filter film 23 can also block ultraviolet.

The color filter substrate 30 includes another glass substrate 31 and a color resist layer 32. The color resist layer 32 is disposed on the glass substrate 31.

The light emitted from the light source is a composite light, which is composed of seven lights of different frequencies of red, orange, yellow, green, cyan, blue, and purple. The wavelengths and frequencies of the lights are different, and there is more blue light on the side close to the light source than on the side away from the light source. Therefore, by providing a blue filter film on the side of the liquid crystal display panel close to the light source, a part of the blue light is filtered by the filter film, thereby reducing the blue light emitted from the light source, and making the color more yellow. Then the color of the light close to the light source is the same with the color of the light away from the light source, and the chromaticity is uniform, which improves the display effect.

In the display module of the present invention, by providing a blue filter film on the side of the liquid crystal display panel close to the light source, a part of the blue light is filtered by the filter film, thereby reducing the blue light emitted from the light source. Therefore, the color of the light close to the light source is the same with the color of the light away from the light source, and the chromaticity is uniform, which improves the display effect.

The present invention further provides an electronic device including any one of the above display modules. The electronic device can be a mobile phone, a tablet, etc.

In the electronic device of the present invention, by providing a blue filter film on the side of the liquid crystal display panel close to the light source, a part of the blue light is filtered by the filter film, thereby reducing the blue light emitted from the light source. Therefore, the color of the light close to the light source is the same with the color of the light away from the light source, and the chromaticity is uniform, which improves the display effect.

The present invention has been disclosed in the above preferred embodiments, but the preferred embodiments are not intended to limit the present invention, and those skilled in the art can make various modifications without departing from the spirit and scope of the invention, so the scope of the present invention is subject to the scope defined by the claims.

What is claimed is:

1. A display module comprising:
a backlight module, comprising a light source; and
a liquid crystal display panel, comprising an array substrate, wherein the array substrate is provided with a blue filter film on a side close to the light source.

2. The display module as claimed in claim 1, wherein a material of the blue filter film comprises at least one of ocular lens pigment (OLP) and melanin.

3. The display module as claimed in claim 2, wherein a mixing ratio of the ocular lens pigment and the melanin is within a predetermined range.

4. The display module as claimed in claim 1, wherein the backlight module further comprises a light guide plate, the light guide plate is disposed above the light source, and the blue filter film is disposed between the light guide plate and a top of the array substrate.

5. The display module as claimed in claim 4, wherein the array substrate comprises a polarizer, and the blue filter film is disposed between the polarizer and the light guide plate.

6. The display module as claimed in claim 5, wherein the blue filter film is attached to the polarizer by an optical adhesive layer.

7. The display module as claimed in claim 1, wherein the array substrate comprises a polarizer and a base substrate, and the blue filter film is disposed between the polarizer and the base substrate.

8. The display module as claimed in claim 7, wherein the base substrate comprises a glass substrate and a switch array layer, the switch array layer is disposed on a second surface of the glass substrate, and the polarizer is disposed on a first surface of the glass substrate.

9. The display module as claimed in claim 8, wherein the blue filter film is disposed between the polarizer and the glass substrate.

10. The display module as claimed in claim 1, wherein the blue filter film is used to filter light having a predetermined wavelength.

11. The display module as claimed in claim 10, wherein the blue filter film is used to block ultraviolet.

12. An electronic device having a display module, comprising:
a backlight module, comprising a light source;
a liquid crystal display panel, comprising an array substrate, wherein the array substrate is provided with a blue filter film on a side close to the light source.

13. The electronic device as claimed in claim 12, wherein the material of the blue filter film comprises at least one of ocular lens pigment and melanin.

14. The electronic device as claimed in claim 12, wherein the backlight module further comprises a light guide plate, the light guide plate is disposed above the light source, and the blue filter film is disposed between the light guide plate and a top of the array substrate.

15. The electronic device as claimed in claim 14, wherein the array substrate comprises a polarizer, and the blue filter film is disposed between the polarizer and the light guide plate.

16. The electronic device as claimed in claim 15, wherein the blue filter film is attached to the polarizer by an optical adhesive layer.

17. The electronic device as claimed in claim 12, wherein the array substrate comprises a polarizer and a base substrate, and the blue filter film is disposed between the polarizer and the base substrate.

18. The electronic device as claimed in claim 17, wherein the base substrate comprises a glass substrate and a switch array layer, the switch array layer is disposed on a second surface of the glass substrate, and the polarizer is disposed on a first surface of the glass substrate.

19. The electronic device as claimed in claim 18, wherein the blue filter film is disposed between the polarizer and the glass substrate.

20. The electronic device as claimed in claim 12, wherein the blue filter film is used to filter light having a predetermined wavelength.
